(19) United States
(12) Patent Application Publication
(10) Pub. No.: US 2008/0055694 A1
(43) Pub. Date: Mar. 6, 2008

(54) Micro-mirror array device

(75) Inventors: Daisuke Matsuo, Tokyo (JP); Nobuyoshi Iwasaki, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 11/897,880

(22) Filed: Aug. 31, 2007

(30) Foreign Application Priority Data
Aug. 31, 2006 (JP) JP 2006-235478

(51) Int. Cl. G02B 26/08

(52) U.S. Cl. 359/226

(57) ABSTRACT

A micro-mirror array device having a plurality of micro-mirrors which can be deflected comprises a first substrate which includes drive electrodes for deflecting the micro-mirrors; and a second substrate which includes a frame area and connecting areas, wherein the connecting areas are formed around the frame area adjacently, and the plurality of the micro-mirrors which are supported to the frame area by elastic members are formed in the frame area, connecting members which connect to the first substrate, are formed in the connecting areas.

### CROSS-REFERENCE TO RELATED APPLICATION

The present application is based upon and claims the benefit of priority from the prior Japanese Patent Application No. 2006-235478 filed on Aug. 31, 2006; the entire content of which are incorporated herein by reference.

### BACKGROUND OF THE INVENTION

1. Field of the Invention

The present invention relates to a micro-mirror array device, and in particular, to a micro-mirror array device which is adopted in a WSS (Wavelength Selective Switch), for example.

2. Description of the Related Art

As it has been disclosed in U.S. Pat. No. 6,442,307, in the hitherto known technology, in a case of connecting a micro-mirror array chip to a driving circuit board, a technology of connecting by using a multiple number of spaces between two mirrors, by an Au bump and a solder bump has been known.

Concretely, for example, as shown in FIG. 12, it is structured by including a mirror layer 20 which includes a mirror 21 which is rotatably installed in a frame 22, and a drive layer 23 (driving circuit board) which includes electrodes 24, and the frame 22 of the mirror layer 20 is connected to the drive layer 23 via a solder ball bond 26 which is provided between metallized areas 25.

As a method of joining the driving circuit board and the frame which includes a micro-mirror array in an abovementioned conventional device, connecting by heating and pressurizing by a method such as flip chip bonding is assumed.

However, when the bump is disposed near a hinge of the micro mirror, a pressure and a temperature at the time of connecting exert to the hinge portion of the mirror via the bump, a mechanical stress and a thermal stress, and further an adverse effect such as a mechanical and thermal damage. Therefore, only mechanical properties of the hinge of the mirror near the bump are changed substantially, which leads to a problem that substantial variation is developed in driving-sensitivity characteristics of the mirror according to a location in the array.

### SUMMARY OF THE INVENTION

The present invention is made in view of the abovementioned circumstances, and an object of the present invention is to reduce an effect on a specific elastic member (hinge) due to a connecting member, and to realize a mirror array of almost uniform characteristics, and to provide a micro-mirror array device which is capable of suppressing a variation in driving-sensitivity characteristics of mirrors in the mirror array.

To solve the abovementioned issues, and to achieve the object, according to the present invention, there is provided a micro-mirror array device having a plurality of micro-mirrors which can be deflected comprises:

a first substrate which includes drive electrodes for deflecting the micro-mirrors; and

a second substrate which includes a frame area and connecting areas, wherein

the connecting areas are formed around the frame area adjacently, and the plurality of the micro-mirrors which are supported to the frame area by elastic members are formed in the frame area, connecting members which connect to the first substrate, are formed in the connecting areas.

According to another aspect of the present invention, there is provided a micro-mirror array device having a plurality of micro-mirrors which can be deflected comprises

a first substrate which includes drive electrodes for deflecting the micro-mirrors; and

a second substrate which includes a frame area and a connecting area, wherein

the connecting area is formed surrounded the frame area, and the plurality of the micro-mirrors which are supported to the frame area by elastic members are formed in the frame area, and connecting members which connect to the first substrate, are formed in the connecting area.

### BRIEF DESCRIPTION OF THE DRAWINGS

FIG. 1 is a diagram showing a top view of a structure of a micro-mirror array device according to a first embodiment of the present invention;

FIG. 2 is a diagram showing bottom view as seen from the micro-mirror array an example of the structure of the micro-mirror array device according to the first embodiment of the present invention;

FIG. 3 is a side sectional view of the micro-mirror array device in FIG. 2;

FIG. 4 is a diagram showing an example of a structure of a micro-mirror array device according to a second embodiment of the present invention;

FIG. 5 is a side sectional view of the micro-mirror array device in FIG. 4;

FIG. 6 is a diagram showing an example of a structure of a micro-mirror array device according to a third embodiment of the present invention;

FIG. 7 is a diagram showing an example of a structure of a micro-mirror array device according to a fourth embodiment of the present invention;

FIG. 8 is a side sectional view of the micro-mirror array device in FIG. 7;

FIG. 9 is a diagram showing an example of a structure of a micro-mirror array device according to a fifth embodiment of the present invention;

FIG. 10 is a diagram showing an example of a structure of a micro-mirror array device according to a sixth embodiment of the present invention;

FIG. 11 is a diagrams showing an example of a structure of a micro-mirror array device according to a seventh embodiment of the present invention; and

FIG. 12 is a diagram showing an example of a structure of a conventional micro-mirror array device.

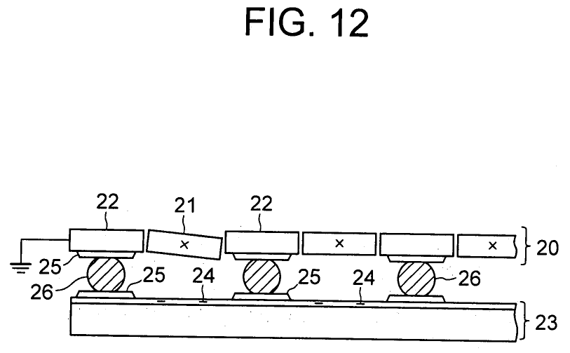

### DETAILED DESCRIPTION OF THE INVENTION

Embodiments of a micro-mirror array device according to the present invention will be described below in detail by referring to the accompanying diagrams. However, the present invention is not restricted to these embodiments.

Moreover, same reference numerals are assigned to components which are same in each embodiment described below, and detailed description of such components may be omitted.

### First Embodiment

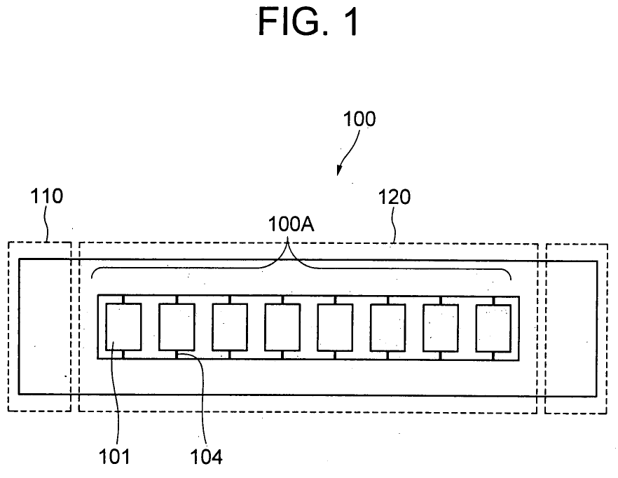

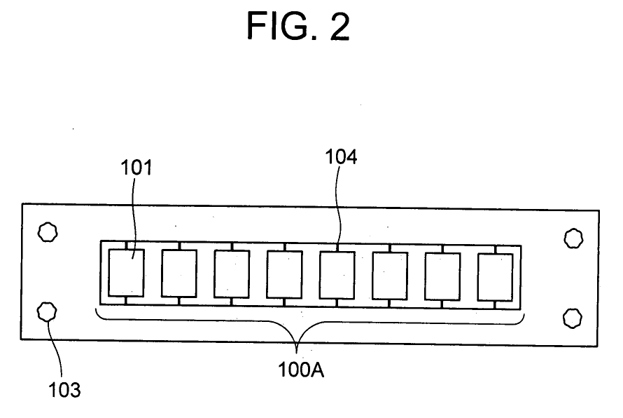

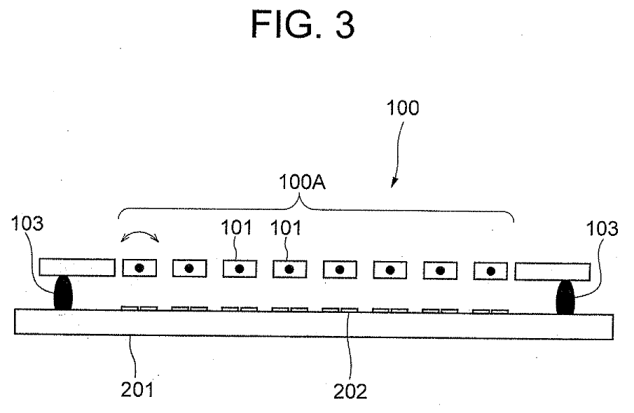

FIG. 1, FIG. 2, and FIG. 3 are diagrams showing a micro-mirror array device 100 according to a first embodiment of the present invention. FIG. 1 shows a top view of the micro-mirror array device 100. FIG. 2 shows a rear view (bottom view) of the micro-mirror array 100A of the micro-mirror array device 100. FIG. 3 shows a cross-sectional view of the micro-mirror array device 100. As shown in FIG. 1 to FIG. 3, the micro-mirror array device 100 is provided with connecting areas 110 on outer sides of a micro-mirror array 100A, and is connected here to a driving circuit board 201.

As shown in FIG. 1 and FIG. 2, a micro-mirror (hereinafter called appropriately as ‘mirror’) 101 and a frame area 120 are connected by a pair of hinges 104 which are elastic members. The micro-mirror 101 is deflectable is a left and right direction in FIG. 1 (in other words, a direction of an arrow in FIG. 3). As shown in FIG. 1, connecting areas 110 are formed adjacent to the frame area 120, on outer sides of the frame area 120. Bumps 103 are formed as the connecting members, in the connecting areas 110.

On the other hand, on the driving circuit board 201, drive electrodes 202 for driving the micro-mirrors 101 by electrostatic force, wires (not shown in the diagram) for passing electricity to the drive electrodes 202 and the micro-mirror array 100A, and pads for connections (not shown in the diagram) are formed.

Moreover, the micro-mirror array 100A is electrically connected to the driving circuit board 201 by the bumps 103 in the connecting areas 110, and the structure is formed such that it is possible to apply a potential difference between the micro-mirrors 101 and the drive electrodes 202.

As the bump 103, solder bump formed of solder, a gold bump formed of a gold wire, and a stud bump can be used.

Accordingly, since the bumps 103 made of a metallic member are disposed, it is possible to connect electrically the micro-mirror array 100A. Moreover, since the bump 103 which is a metallic member is subjected to plastic deformation by external force, it is possible to deform the metallic member appropriately such that the frame area 120 is formed to be flat. Consequently, it is possible to achieve a micro-mirror array device having a high flatness of the frame area 120, in which it is possible to connect electrically to the micro-mirror array.

Moreover, since the connecting areas 110 are disposed separately, independent of the frame area 120 which holds the plurality of micro-mirrors 101, the hinges 104 does not have an effect of heat and stress when the micro-mirror array 100A is electrically connected to the driving circuit board 201 by the bumps 103.

Consequently, a specific hinge 104 does not have an effect of the connecting area 110. It is possible to achieve the micro-mirror array device 100 in which all the mirrors 101 have uniform driving characteristics.

Moreover, since the bumps 103 have electrical conductivity, it is possible to electrically connect the mirror array to a desired part, and to apply a desired electric potential. Therefore, it is possible to let the micro-mirror 101 to be deflectable by electrical driving force. Consequently, it is possible to achieve the micro-mirror array device 100 which can be driven.

By using a semiconductor substrate of a material such as Si for the frame area 120 and the driving circuit board 201, it is possible to form an array structure which is highly densified, and fine. It is needless to mention that it is possible to use various materials which fall within the scope of a concept of the present invention.

Furthermore, by forming the connecting areas 110 and the frame area 120 by the same material, but as separate areas, necessary functions are exhibited. However, it is also useful to select different materials intentionally, and to let to have even stronger effect.

According to the micro-mirror array device according to the first embodiment having the abovementioned structure, since the connecting areas 110 are disposed separately from the frame area 120, the elastic members (hinges) 104 does not have an effect of heat and mechanical stress from the connecting member such as the bumps 103.

In this manner, since the bumps are provided only in the connecting areas on the outer sides of the mirror array, as a distance between the bump and the hinge becomes longer, a range of transmission of heat and a thermal stress is restricted to the connecting areas when the bumps 103 are connected. In other words, since there is no mirror which is specifically close to the bump, there is no mirror having a substantial effect on characteristics of the hinge. Therefore, it is possible to prevent a substantial variation in the driving characteristics of each mirror.

In other words, the specific hinge 104 does not have an effect of the bump 103. It is possible to achieve a micro-mirror array device in which all the micro-mirrors have uniform driving characteristics.

Furthermore, in one-dimensional array, since the frame area 120 has a long and slender structure in a one-dimensional direction, an effect of the connecting member, such as the frame is susceptible to be deformed due to the effect, is particularly substantial. In the first embodiment, since the connecting areas 110 are provided on the outer sides of the frame area 120, the hinges 104 of the mirror 101 do not have an effect easily of the connecting member (bump). Therefore, even in one-dimensional array, the hinges 104 of all mirrors 101 can maintain almost uniform characteristics.

### Second Embodiment

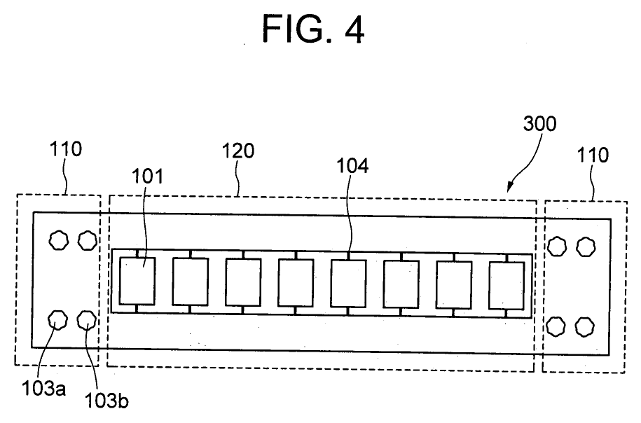

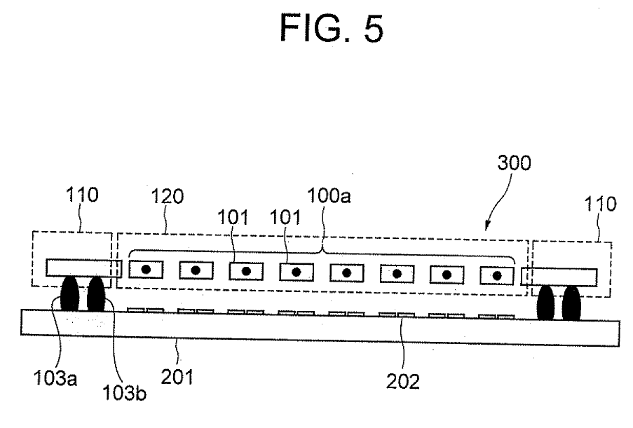

Next, a second embodiment of the present invention will be described below. FIG. 4 and FIG. 5 are diagrams showing a micro-mirror array device 300 according to the second embodiment of the present invention. FIG. 4 shows a bottom view of the micro-mirror array of the micro-mirror array device 300. FIG. 5 shows a cross-sectional view of the micro-mirror array device 300.

The second embodiment, shows an example in which bumps 103a and 103b are disposed as two connecting members, in the connecting areas 110 similar as described by referring to FIG. 1.

In the second embodiment, as shown in FIG. 4 and FIG. 5, the connecting areas 110 are provided on the outer sides of the frame area 120 of the one-dimensional micro-mirror array 100A, and in the connecting areas 110, the two bumps 103a, and 103b are arranged in a direction of arrangement (direction of a row) of the micro-mirror array 100A, thereby providing eight bumps in all, at four locations.

The connecting areas 110 are electrically and mechanically connected to the driving circuit board 201 by using the bumps 103a and 103b.

Each of the micro-mirrors 101 is structured to be driven independently by electrostatic force, by the drive electrode 202 on the driving circuit board 201.

Here, for example, a case in which the micro-mirror array 100A is curved in a longitudinal direction (direction of arrangement of the array) can also be taken into consideration. In this case, since a distance from the driving circuit board 201 differs for each micro-mirror 101, the electrostatic force differs, and there is a possibility that respective driving sensitivity changes.

As a result of this, there is a difference in a range in which it can be driven, and a resolution which drives, for each micro-mirror 101, and it may not be possible to achieve a uniform micro-mirror array.

Even in such a case, according to the micro-mirror array device according to the second embodiment, by arranging the plurality of bumps 103a and 103b in the direction of arrangement (direction of a row) of the micro-mirror array 100A, the micro-mirror array 100A can be supported such that a curvature of the micro-mirror array 100A is mechanically corrected. Therefore, it is possible to make constant the distance between the micro-mirror 101 and the drive electrode 202.

In the one-dimensional mirror array, the connecting areas 110 are disposed on outer sides of the direction of arrangement (direction of a row) of the array. In other words, since it is connected by both ends of a long and slender array, and an area near central portion is not constrained, the entire array is susceptible to bending. In the present invention, the plurality of bumps 103a and 103b (connecting members) made of metallic member are disposed in the direction of arrangement of the array. Therefore, it is possible to fix an inclination of the connecting areas 110 substantial parallel to the driving circuit board 201 at a plurality of points to which the metallic member is connected. According to this effect, it is possible to suppress the bending of the entire array. As a result, a gap between the mirror 101 and the electrode becomes uniform for the entire array, and not only the hinge characteristics, but also the driving force also becomes uniform. Consequently, it is possible to achieve a mirror array device in which, the driving characteristics are same for all the mirrors 101.

### Third Embodiment

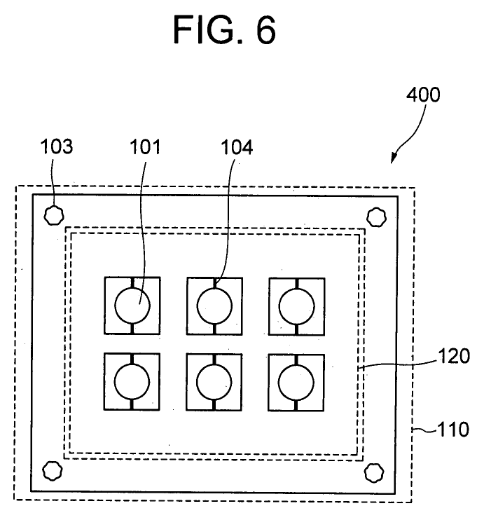

Next, a third embodiment of the present invention will be described below. FIG. 6 shows a bottom view of the micro-mirror array of a micro-mirror array device 400 according to a third embodiment of the present invention.

The third embodiment is an example applicable to a two-dimensional array. As shown in FIG. 6, even in the two-dimensional array, by proving the bumps 103 in the connecting area 110 which is disposed separately from the frame area 120, it is possible to avoid an adverse effect on the hinges 104 of the micro-mirror 101 by connecting with the bumps 103.

Consequently, even in the third embodiment, it is possible to realize a micro-mirror array device in which all the mirrors have the uniform driving characteristics.

### Fourth Embodiment

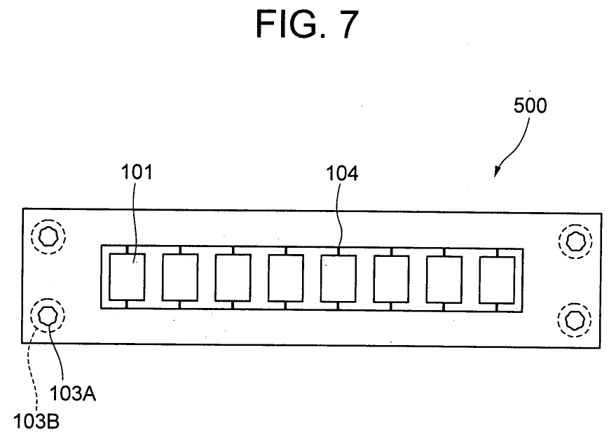

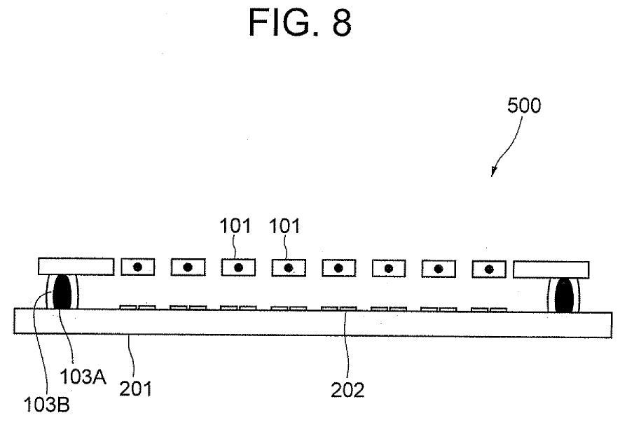

Next, a fourth embodiment of the present invention will be described below. FIG. 7 shows a bottom view of a micro-mirror array device 500 of the micro-mirror array according to the fourth embodiment of-the present invention. FIG. 8 shows a cross-sectional view of the micro-mirror array device 500.

The fourth embodiment shows an example in which, a metallic member 103A and an adhesive 103B are used as the connecting member. Concretely, it is possible to use a stud bump of gold for example, as the metallic member 103A, and to use an epoxy-based adhesive for electrical mounting (NCP: Non Conductive Paste) for example, as the adhesive 103B.

In the fourth embodiment, since the connecting member is formed by the metallic material 103A and the adhesive 103B, it is possible to let electrical connections to function by electroconductivity of the metallic member 103A, and to let mechanical connections to function by the adhesive 103B.

Consequently, it is possible to achieve a micro-mirror array device having both a high conductivity and a strong connecting power, and which is highly durable.

### Fifth Embodiment

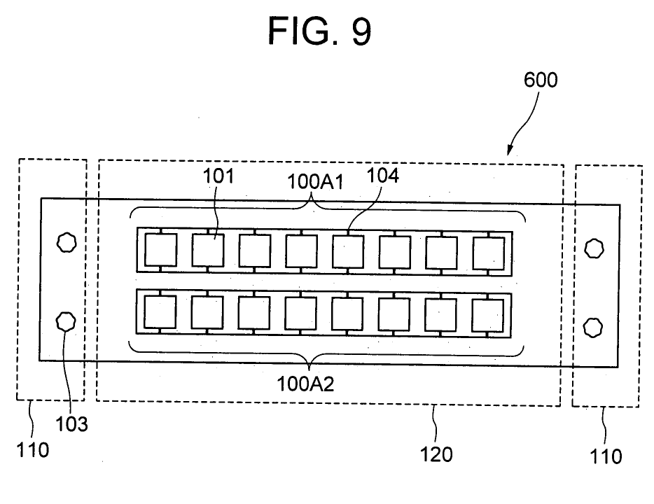

Next, a fifth embodiment of the present invention will be described below. FIG. 9 is a diagram showing a micro-mirror array device 600 according to the fifth embodiment of the present invention. The fifth embodiment shows an example in which one-dimensional micro-mirror array is disposed in two parallel rows.

In the fifth embodiment, for example, an upper row 100A1 of the micro-mirror array in FIG. 9 is used for an optical switch, and a lower row 100A2 is used for a back-up thereof. When there is a failed micro-mirror 101 in the upper row 100A1, it is switched to a route in which light is guided to the lower row 100A2, and by using the micro-mirror 101 on the lower side, it is possible to avoid a break-down as a system.

In other words, in the fifth embodiment, it is possible to further improve a reliability of the system, in addition to show an action and effect similar as in the first embodiment described above.

In this manner, even when a plurality of rows of one-dimensional array is disposed, since the bump 103 is disposed only in the connecting area 110, the hinge 104 of the mirror 101 does not have an effect of the bump 103. Consequently, it is possible to achieve a micro-mirror array device having a plurality of one-dimensional arrays, with all uniform characteristics. As it has been mentioned above, since each of the one-dimensional arrays has main applications and a back-up at the time of break-down, or can be used for other application, it is possible to achieve a micro-mirror array having a plurality of functions.

### Sixth Embodiment

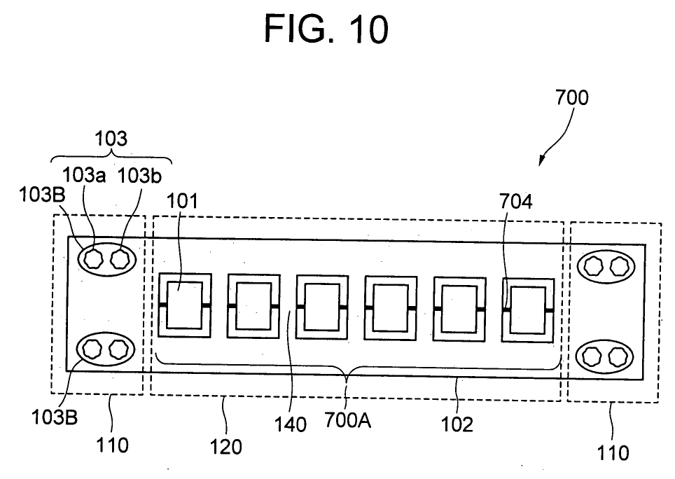

Next, a sixth embodiment of the present invention will be described below. FIG. 10 is a diagram showing a micro-mirror array device 700 according to the sixth embodiment of the present invention. The sixth embodiment, as shown in FIG. 10, shows an example of a one-dimensional micro-mirror array device which has micro-mirrors 101 deflectable around an axis parallel to a direction of arrangement (direction of a row) of the micro-mirrors 101.

As shown in FIG. 10, in the sixth embodiment, hinges 704 are provided on both left and right sides of the micro-mirror 101, and due to the hinges 704 on both sides, a micro-mirror array 700A is deflectable around an axis parallel to the direction of arrangement of the micro-mirrors 101.

The hinges 704 are supported by beams 140 which are connected to the frame 102. In other words, the micro-mirrors 101 are supported integrally by the frame 102 to form the micro-mirror array.

On the other hand, on left and right sides of the frame area 120 similar as described by referring to FIG. 1, the connecting areas 110 for disposing the bumps 103a and 103b are provided, which does not have an adverse effect on the hinges 704 of the micro-mirror 101. For preventing the connecting member from bending in a longitudinal direction of the micro-mirror array 700A, the two bumps 103a and 103b are disposed as the connecting member 103 by arranging in the longitudinal direction. A set of these two bumps 103a and 103b is disposed at four locations in the frame area 120, and are electrically and mechanically connected to a circuit board not shown in the diagram.

As in the sixth embodiment, in the micro-mirror array device 700 provided with the micro-mirrors 101 which are deflected around an axis parallel to the direction of arrangement of the micro-mirror array 700A, when the long frame area is distorted to be curved, it has various inclinations around an axis orthogonal to the axis around which the micro-mirrors 101 are deflected. However, since it is not possible to be deflected around the axis orthogonal to the axis around which the micro-mirrors 101 are deflected, it is not possible to correct the inclination.

In the sixth embodiment, since the connecting member 103 is structured such that the plurality of bumps 103a and 103b are disposed by arranging in the direction of arrangement of the micro-mirrors 101, it is possible to suppress the curve of the frame area 120 to be the minimum.

Consequently, it is possible to achieve a micro-mirror array device which cannot have an undesirable inclination in a direction in which the mirror can not be deflected.

It is possible to structure the connecting member only by bumps, or by the metallic member and the adhesive described in the fourth embodiment. However, in the micro-mirror array device 700 provided with the micro-mirrors 101 which are deflected around the axis parallel to the direction of arrangement of the micro-mirror array 700A in the sixth embodiment, by forming the connecting member 103 by the bumps 103a and 103b, it is possible to make an action and effect even more remarkable.

Moreover, it is also possible to form a plurality of rows of the one-dimensional arrays 700A in the frame area 120.

### Seventh Embodiment

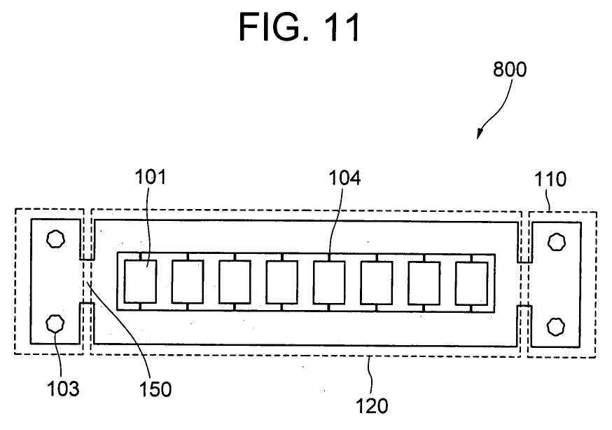

Next, a seventh embodiment of the present invention will be described below. FIG. 11 is a diagram showing a micro-mirror array device 800 according to the seventh embodiment of the present invention.

In the seventh embodiment, as shown in FIG. 11, a bridge area 150 is provided for separating more effectively the frame area 120 and the connecting area 110. Due to the bridge area 150, since it is possible to make the micro-mirror 101 not to have an effect so easily of the bump 103 which is corresponded to the connecting member disposed in the connecting area, it is possible to realize a micro-mirror array device having even more uniform characteristics.

As it has been described above, the entire structure in which, an arrangement is made such that the frame area 120 and the micro-mirror 101 are not let to have the effect of the connection by the connecting member in the connecting area 110, by providing the connecting area 110 around the frame area 120 adjacently, is in accordance with a basic concept of the present invention, and it is possible to make various modifications in this structure.

As it has been described above, the micro-mirror array device according to the present invention is useful as a micro-mirror array device in which a high optical quality is sought, and is suitable as a micro-mirror array device used in a WSS.

According to the present invention, it is possible to reduce an effect on a specific elastic member (hinge) due to a connecting member, and to realize a mirror array of almost uniform characteristics, and to provide a micro-mirror array device in which a variation in the driving-sensitivity characteristics of mirrors in the mirror array is suppressed.

What is claimed is:

1. A micro-mirror array device having a plurality of micro-mirrors which can be deflected comprising:
a first substrate which includes drive electrodes for deflecting the micro-mirrors; and
a second substrate which includes a frame area and connecting areas, wherein
the connecting areas are formed around the frame area adjacently, and the plurality of the micro-mirrors which are supported to the frame area by elastic members are formed in the frame area, connecting members which connect to the first substrate, are formed in the connecting areas.

2. The micro-mirror array device according to claim 1, wherein
a position where the connecting members of the connecting areas are formed, is a position separated in order to substantially decrease an effect of heat and mechanical stress with respect to a position where the elastic members and the micro-mirrors are formed.

3. The micro-mirror array device according to claim 2, wherein
a plurality of the connecting members is formed in the connecting areas, and
the connecting members are electrically conductive.

4. The micro-mirror array device according to claim 3, wherein
in the frame areas, a mirror array in which the micro-mirrors are arranged one-dimensionally is formed, and
the connecting areas are disposed on outer sides of the frame area, in a direction of arrangement of the micro-mirror array.

5. The micro-mirror array device according to claim 3, wherein
the connecting member is made of a metallic member.

6. The micro-mirror array device according to claim 3, wherein
the connecting member is formed of a metallic member and an adhesive.

7. The micro-mirror array device according to claim 4, wherein
in a direction of arrangement of the micro-mirror array, there are connecting areas in which a plurality of connecting members are disposed by arranging.

8. The micro-mirror array device according to claim 7, wherein
in the frame area, a plurality of rows of the micro-mirror arrays arranged one-dimensionally are disposed in parallel.

9. The micro-mirror array device according to claim 7, wherein
the micro-mirrors in the micro-mirror array are deflectable around an axis parallel to the direction of arrangement of the micro-mirrors.

10. The micro-mirror array device according to claim 1, wherein
the frame area is disposed adjacent to the elastic members to hold the plurality of micro-mirrors integrally in a space, and
the connecting areas are provided on outer sides of the frame area to hold the frame area in a space.

11. The micro-mirror array device according to claim 10, wherein
a plurality of the connecting members are formed in the connecting areas, and
the connecting members are electrically conductive.

12. The micro-mirror array device according to claim 11, wherein
a mirror array in which the micro-mirrors are arranged one-dimensionally is formed in the frame area, and
the connecting areas are disposed on the outer sides of the frame area, in a direction of arrangement of the micro-mirror array.

13. The micro-mirror array device according to claim 11, wherein
the connecting member is made of a metallic member.

14. The micro-mirror array device according to claim 11, wherein
the connecting member is formed of a metallic member and an adhesive.

15. The micro-mirror array device according to claim 12, wherein
in the direction of arrangement of the micro-mirror array, there are connecting areas in which a plurality of connecting members are disposed by arranging.

16. The micro-mirror array device according to claim 15, wherein
in the frame area, a plurality of rows of the micro-mirror arrays arranged one-dimensionally are disposed in parallel.

17. The micro-mirror array device according to claim 15, wherein
the micro-mirrors in the micro-mirror array are deflectable around an axis parallel to the direction of arrangement of the micro-mirrors.

18. The micro-mirror array device according to claim 1, wherein
the connecting member is formed of a metallic member and an adhesive.

19. A micro-mirror array device having a plurality of micro-mirrors which can be deflected comprising:
a first substrate which includes drive electrodes for deflecting the micro-mirrors; and
a second substrate which includes a frame area and a connecting area, wherein
the connecting area is formed surrounded the frame area, and the plurality of the micro-mirrors which are supported to the frame area by elastic members are formed in the frame area, and connecting members which connect to the first substrate, are formed in the connecting area.
